(19) United States
(12) Patent Application Publication
(10) Pub. No.: US 2025/0155712 A1
(43) Pub. Date: May 15, 2025

(54) LIGHT SOURCE FOR PICTURE GENERATION UNIT IN HUD

(71) Applicant: Shenzhen Raythink Automotive Electronics Co., Ltd., Shenzhen (CN)

(72) Inventors: Chin Lun Chang, Shenzhen (CN); Rui Lu, Shenzhen (CN); Shuguang Huang, Shenzhen (CN)

(21) Appl. No.: 18/506,153

(22) Filed: Nov. 10, 2023

(51) Int. Cl. G02B 27/01; G02B 27/10; G02B 27/14

(52) U.S. Cl. CPC G02B 27/0172; G02B 27/102; G02B 27/141

(57) ABSTRACT

Disclosed is a light source for a picture generation unit in a head up display (HUD), including: at least two light emitting assemblies, each configured to emit at least three colors of light; and a light combining assembly, including a dichroic beam splitter and combiner mirror, a half-wave plate, and a polarizing beam splitter mirror, where the dichroic beam splitter and combiner mirror is arranged on light emitting paths of the light emitting assemblies and configured to combine the at least three colors of light emitted by each of the light emitting assemblies into combined light, the half-wave plate is arranged on a light emitting path of one ray of the combined light and configured to change a polarization characteristic of the combined light.

### FIELD OF TECHNOLOGY

The present utility model relates to the technical field of HUDs, in particular to a light source for a picture generation unit in an HUD.

### BACKGROUND

A head up display is abbreviated as HUD. At present, HUDs are widely used in flight aids for aircrafts and now have been gradually popularized in cars. HUDs are designed to improve the safety of cars and keep the driver's attention on the road to reduce accidents.

In the prior art, an HUD installed on a car adopts a light source structure of laser beam scanning (LBS for short), a laser light source thereof is usually arranged separately, and under this condition, a corresponding beam splitter and combiner prism is also arranged separately. As a result, a light source for a picture generation unit has problems of large size and occupied space, difficulty in installation and maintenance, etc., and is not conducive to introducing a cooling solution under the condition of occupying a large space, thereby affecting the final picture display effect.

### SUMMARY

An objective of the present utility model is to provide a light source for a picture generation unit in an HUD. In the light source, the light emitting assemblies are intensively arranged, which may reduce the installation size of the light source for the picture generation unit, and avoid occupying a large space, to facilitate introduction of a cooling solution, thereby improving the overall cooling efficiency of the light source. Moreover, due to the light source focused, the light emitting brightness may be improved, and heat is relatively concentrated, such that the problem of temperature imbalance between the light emitting assemblies may be avoided, and the temperature monitoring precision of an external temperature control monitoring device for the light source may be improved. Furthermore, the light source is reasonable in overall design, compact in structure, convenient to install and maintain, and high in practicality.

To achieve the above objective, the following technical solution is adopted:

A light source for a picture generation unit in an HUD, including:
at least two light emitting assemblies, each configured to emit at least three colors of light; and
a light combining assembly, including a dichroic beam splitter and combiner mirror, a half-wave plate, and a polarizing beam splitter mirror,
where the dichroic beam splitter and combiner mirror is arranged on light emitting paths of the light emitting assemblies and configured to combine the at least three colors of light emitted by each of the light emitting assemblies into combined light, the half-wave plate is arranged on a light emitting path of one ray of the combined light and configured to change a polarization characteristic of the combined light, and the polarizing beam splitter mirror is configured to combine the combined light emitted from the half-wave plate with another ray of the combined light.

Further, there are two light emitting assemblies, each including at least one first light emitting element, at least one second light emitting element, and at least one third light emitting element; and the first light emitting element, the second light emitting element, and the third light emitting element are configured to emit a first color of light, a second color of light, and a third color of light, respectively.

Further, a collimating lens is further arranged on each of light emitting paths of the first light emitting element, the second light emitting element, and the third light emitting element.

Further, both the half-wave plate and the polarizing beam splitter mirror are arranged at a top of the dichroic beam splitter and combiner mirror.

Further, the dichroic beam splitter and combiner mirror is provided with a first dichroic beam splitting and combining surface, a second dichroic beam splitting and combining surface, and a third dichroic beam splitting and combining surface; the first dichroic beam splitting and combining surface is configured to reflect the first color of light to the second dichroic beam splitting and combining surface; the second dichroic beam splitting and combining surface is configured to transmit the first color of light to the third dichroic beam splitting and combining surface, and to reflect the second color of light to the third dichroic beam splitting and combining surface; the third dichroic beam splitting and combining surface is configured to transmit the third color of light to the half-wave plate and the polarizing beam splitter mirror, and to reflect the first color of light and the second color of light to the half-wave plate and the polarizing beam splitter mirror; and the first color of light, the second color of light, and the third color of light incident into the half-wave plate are combined into first combined light, and the first color of light, the second color of light, and the third color of light incident into the polarizing beam splitter mirror are combined into second combined light.

Further, both the half-wave plate and the polarizing beam splitter mirror are arranged at one end of the dichroic beam splitter and combiner mirror.

Further, the dichroic beam splitter and combiner mirror is provided with a first dichroic beam splitting and combining surface, a second dichroic beam splitting and combining surface, and a third dichroic beam splitting and combining surface; the first dichroic beam splitting and combining surface is configured to reflect the first color of light to the second dichroic beam splitting and combining surface; the second dichroic beam splitting and combining surface is configured to transmit the first color of light to the third dichroic beam splitting and combining surface, and to reflect the second color of light to the third dichroic beam splitting and combining surface; the third dichroic beam splitting and combining surface is configured to transmit the first color of light and the second color of light to the half-wave plate and the polarizing beam splitter mirror, and to reflect the third color of light to the half-wave plate and the polarizing beam splitter mirror; and the first color of light, the second color of light, and the third color of light incident into the half-wave plate are combined into first combined light, and the first color of light, the second color of light, and the third color of light incident into the polarizing beam splitter mirror are combined into second combined light.

Further, the polarizing beam splitter mirror is provided with a fourth beam splitting and combining surface and a fifth beam splitting and combining surface; the fourth beam splitting and combining surface is configured to reflect the first combined light emitted from the half-wave plate to the fifth beam splitting and combining surface; and the fifth beam splitting and combining surface is configured to transmit the second combined light, and to reflect the first combined light to a light emitting direction of the second combined light.

Further, the two light emitting assemblies are arranged side by side.

Further, the first light emitting element, the second light emitting element, and the third light emitting element are all laser diodes.

With the above technical solution, the present utility model has the following beneficial effects:

The light emitting assemblies are intensively arranged, which may reduce the installation size of the light source for the picture generation unit, and avoid occupying a large space, to facilitate introduction of a cooling solution, thereby improving the overall cooling efficiency of the light source. Moreover, due to the light source focused, the light emitting brightness may be improved, and heat is relatively concentrated, such that the problem of temperature imbalance between the light emitting assemblies may be avoided, and the temperature monitoring precision of an external temperature control monitoring device for the light source may be improved. Furthermore, the light source is reasonable in overall design, compact in structure, convenient to install and maintain, and high in practicality.

### BRIEF DESCRIPTION OF THE DRAWINGS

FIG. 1 is a three-dimensional view of an embodiment of the present utility model;

FIG. 2 is a front view of FIG. 1;

FIG. 3 is a right view of FIG. 1; and

FIG. 4 is a front view of another embodiment of the present utility model.

### DESCRIPTION OF REFERENCE NUMERALS

1—light emitting assembly; 2—light combining assembly;
3—reflecting element; 4—micro-electromechanical system (MEMS) mirror;
11—first light emitting element; 12—second light emitting element;
13—third light emitting element; 14—collimating lens;
21—dichroic beam splitter and combiner mirror; 22—half-wave plate;
23—polarizing beam splitter mirror; 211—first dichroic beam splitting and combining surface;
212—second dichroic beam splitting and combining surface; 213—third dichroic beam splitting and combining surface;
231—fourth beam splitting and combining surface; and 232—fifth beam splitting and combining surface.

### DESCRIPTION OF THE EMBODIMENTS

The present utility model is described in detail below with reference to the accompanying drawings and specific embodiments.

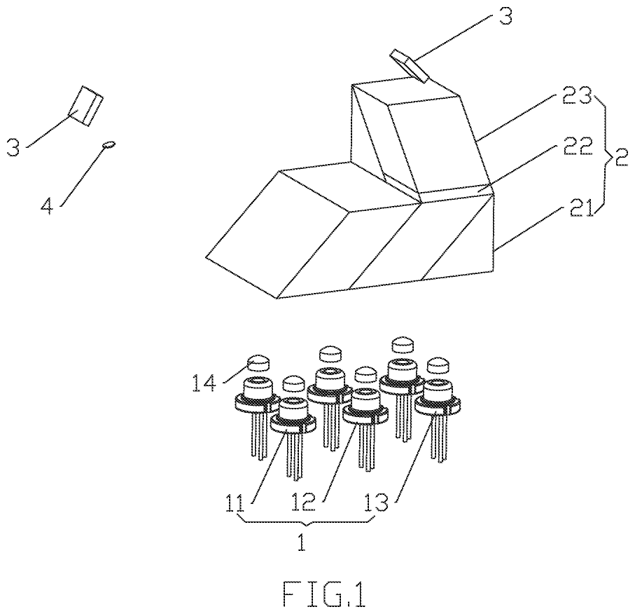

Referring to FIGS. 1 to 4, the present utility model provides a light source for a picture generation unit in a head up display (HUD), including:
at least two light emitting assemblies 1, each configured to emit at least three colors of light; and
a light combining assembly 2, including a dichroic beam splitter and combiner mirror 21, a half-wave plate 22, and a polarizing beam splitter mirror 23,
where the dichroic beam splitter and combiner mirror 21 is arranged on light emitting paths of the light emitting assemblies 1 and configured to combine the at least three colors of light emitted by each of the light emitting assemblies 1 into combined light, the half-wave plate 22 is arranged on a light emitting path of one ray of the combined light and configured to change a polarization characteristic of the combined light, and the polarizing beam splitter mirror 23 is configured to combine the combined light emitted from the half-wave plate 22 with another ray of the combined light.

There are two light emitting assemblies 1, each including at least one first light emitting element 11, at least one second light emitting element 12, and at least one third light emitting element 13; the first light emitting element 11, the second light emitting element 12, and the third light emitting element 13 are configured to emit a first color of light, a second color of light, and a third color of light, respectively; and a collimating lens 14 is further arranged on each of light emitting paths of the first light emitting element 11, the second light emitting element 12, and the third light emitting element 13.

Referring to FIG. 1, in an embodiment, both the half-wave plate 22 and the polarizing beam splitter mirror 23 are arranged at a top of the dichroic beam splitter and combiner mirror 21; the dichroic beam splitter and combiner mirror 21 is provided with a first dichroic beam splitting and combining surface 211, a second dichroic beam splitting and combining surface 212, and a third dichroic beam splitting and combining surface 213; the first dichroic beam splitting and combining surface 211 is configured to reflect the first color of light to the second dichroic beam splitting and combining surface 212; the second dichroic beam splitting and combining surface 212 is configured to transmit the first color of light to the third dichroic beam splitting and combining surface 213, and to reflect the second color of light to the third dichroic beam splitting and combining surface 213; the third dichroic beam splitting and combining surface 213 is configured to transmit the third color of light to the half-wave plate 22 and the polarizing beam splitter mirror 23, and to reflect the first color of light and the second color of light to the half-wave plate 22 and the polarizing beam splitter mirror 23; and the first color of light, the second color of light, and the third color of light incident into the half-wave plate 22 are combined into first combined light, and the first color of light, the second color of light, and the third color of light incident into the polarizing beam splitter mirror 23 are combined into second combined light.

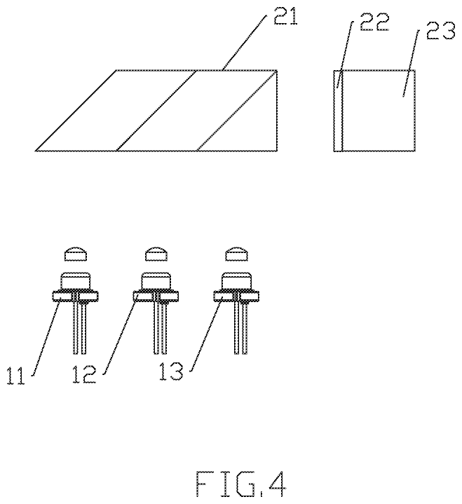

Referring to FIG. 4, in another embodiment, both the half-wave plate 22 and the polarizing beam splitter mirror 23 are arranged at one end of the dichroic beam splitter and combiner mirror 21; the dichroic beam splitter and combiner mirror 21 is provided with a first dichroic beam splitting and combining surface 211, a second dichroic beam splitting and combining surface 212, and a third dichroic beam splitting and combining surface 213; the first dichroic beam splitting and combining surface 211 is configured to reflect the first color of light to the second dichroic beam splitting and combining surface 212; the second dichroic beam splitting and combining surface 212 is configured to transmit the first color of light to the third dichroic beam splitting and combining surface 213, and to reflect the second color of light to the third dichroic beam splitting and combining surface 213; the third dichroic beam splitting and combining surface 213 is configured to transmit the first color of light and the second color of light to the half-wave plate 22 and the polarizing beam splitter mirror 23, and to reflect the third color of light to the half-wave plate 22 and the polarizing beam splitter mirror 23; and the first color of light, the second color of light, and the third color of light incident into the half-wave plate 22 are combined into first combined light, and the first color of light, the second color of light, and the third color of light incident into the polarizing beam splitter mirror 23 are combined into second combined light.

Based on the above embodiments, the polarizing beam splitter mirror 23 is provided with a fourth beam splitting and combining surface 231 and a fifth beam splitting and combining surface 232; the fourth beam splitting and combining surface 231 is configured to reflect the first combined light emitted from the half-wave plate 22 to the fifth beam splitting and combining surface 232; the fifth beam splitting and combining surface 232 is configured to transmit the second combined light, and to reflect the first combined light to a light emitting direction of the second combined light; the two light emitting assemblies 1 are arranged side by side; and the first light emitting element 11, the second light emitting element 12, and the third light emitting element 13 are all laser diodes.

The working principle of the present utility model is as follows:

Continuing referring to FIGS. 1 to 4, the light source serves as a picture source for the HUD; picture light emitted by the light source is reflected through a plurality of external reflecting elements 3 to a micro-electromechanical system (MEMS) mirror 4 (an MEMS tilting mirror); projected picture light is formed through the MEMS mirror 4 and is emitted to a front windshield of a car through an optical path display system of the HUD; and a user may observe a projected virtual image by reflection of the front windshield.

There are at least two light emitting assemblies 1, and a specific number thereof may be freely set according to an actual requirement. In an embodiment, there are two light emitting assemblies 1 arranged side by side, and each light emitting assembly 1 may be configured to emit at least three colors of light. In an embodiment, each light emitting assembly 1 includes three light emitting elements, each configured to emit a color of light. In an embodiment, the three colors of light emitted by each light emitting assembly 1 are red light, blue light, and green light, respectively, that is, the light emitted by the three light emitting elements of each light emitting assembly 1 is any permutation and combination of the red light, the blue light, and the green light, for example, the first light emitting element 11 emits the red light, the second light emitting element 12 emits the blue light, the third light emitting element 13 emits the green light, or the first light emitting element 11 emits the blue light, the second light emitting element 12 emits the red light, and the third light emitting element 13 emits the green light, etc. In order to focus the light source, in an embodiment, a collimating lens 14 is arranged on a light emitting path of each light emitting element and may converge the light emitted by the light emitting element to form parallel light to be outputted, and the light outputted in parallel will be combined through the light combining assembly 2. The principle is described below by an embodiment where the first light emitting element 11 emits the blue light, the second light emitting element 12 emits the green light, and the third light emitting element 13 emits the red light.

Continuing referring to FIG. 1, in an embodiment, both the half-wave plate 22 and the polarizing beam splitter mirror 23 are arranged at a top of the dichroic beam splitter and combiner mirror 21; the dichroic beam splitter and combiner mirror 21 is provided with a first dichroic beam splitting and combining surface 211, a second dichroic beam splitting and combining surface 212, and a third dichroic beam splitting and combining surface 213, where the first dichroic beam splitting and combining surface 211 is configured to reflect the first color of light, i.e., the blue light to the second dichroic beam splitting and combining surface 212; the second dichroic beam splitting and combining surface 212 is configured to transmit the first color of light (the blue light) to the third dichroic beam splitting and combining surface 213, and to reflect the second color of light, i.e., the green light to the third dichroic beam splitting and combining surface 213; and the third dichroic beam splitting and combining surface 213 is configured to transmit the third color of light (the red light) to the half-wave plate 22 and the polarizing beam splitter mirror 23, and to reflect the first color of light (the blue light) and the second color of light (the green light) to the half-wave plate 22 and the polarizing beam splitter mirror 23.

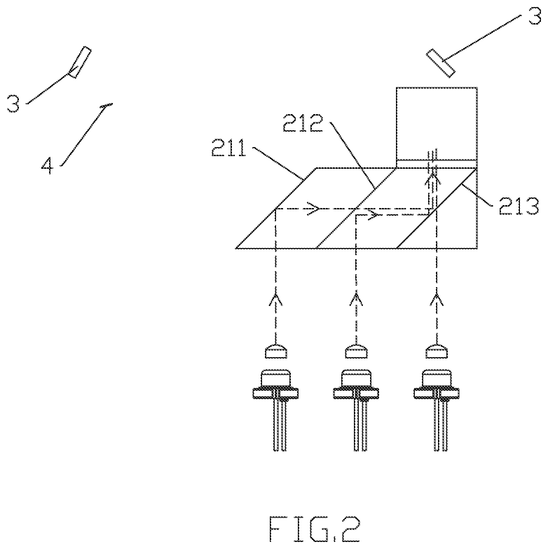

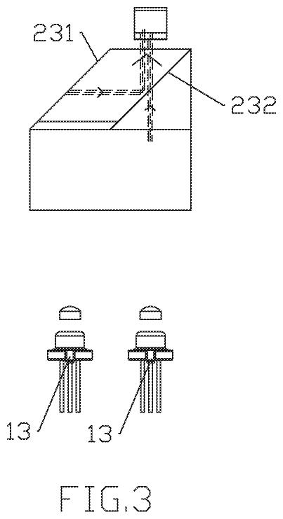

The light emitted by the two light emitting assemblies 1 has the same polarization characteristic. The blue light emitted by the two first light emitting elements 11 is both reflected by the first dichroic beam splitting and combining surface 211 (for an optical transmission path, reference may be made to dashed lines in FIGS. 2 and 3) to the second dichroic beam splitting and combining surface 212; at the second dichroic beam splitting and combining surface 212, the blue light is transmitted, and the green light emitted by the two second light emitting elements 12 is reflected, that is, at the second dichroic beam splitting and combining surface 212, the blue light and the green light are combined; at the third dichroic beam splitting and combining surface 213, the blue light and the green light are reflected, and the red light emitted by the two third light emitting elements 13 is transmitted, that is, at the third dichroic beam splitting and combining surface 213, the blue light, the green light, and the red light are combined on a light emitting surface thereof, and the polarization characteristic of the combined light remains unchanged; when one (the first combined light) of two rays of the combined lights is emitted through the half-wave plate 22, the polarization characteristic of the first combined light is changed, and polarization directions of the first combined light and the second combined light are perpendicular to each other; and then, the first combined light is reflected to the light emitting direction of the second combined light through the fourth beam splitting and combining surface 231 and the fifth beam splitting and combining surface 232 of the polarizing beam splitter mirror 23 to obtain a final combined beam, the combined beam is reflected through a plurality of external reflecting elements 3 and then emitted to a front windshield of a car, and a projected virtual image is formed by reflection of the front windshield.

As shown in FIG. 4, in an embodiment, the half-wave plate 22 and the polarizing beam splitter mirror 23 may be arranged at one end of the dichroic beam splitter and combiner mirror 21. In this case, the first dichroic beam splitting and combining surface 211 and the second dichroic beam splitting and combining surface 212 on the dichroic beam splitter and combiner mirror 21 have the same principle as that above. The third dichroic beam splitting and combining surface 213 is configured to transmit the first color of light and the second color of light to the half-wave plate 22 and the polarizing beam splitter mirror 23, and to reflect the third color of light to the half-wave plate 22 and the polarizing beam splitter mirror 23.

The light emitting elements are devices capable of emitting beams. In an embodiment, the first light emitting element 11, the second light emitting element 12, and the third light emitting element 13 are all laser diodes. In an embodiment, the beam splitter and combiner mirror 21 is a beam splitter and combiner prism.

The above are only the preferred embodiments of the present utility model and are not intended to limit the present utility model. Any modifications, equivalent substitutions and improvements, etc. made within the spirit and principle of the present utility model shall be included within the scope of protection of the present utility model.

What is claimed is:

1. A light source for a picture generation unit in a head up display (HUD), comprising:
at least two light emitting assemblies, each configured to emit at least three colors of light; and
a light combining assembly, comprising a dichroic beam splitter and combiner mirror, a half-wave plate, and a polarizing beam splitter mirror,
wherein the dichroic beam splitter and combiner mirror is arranged on light emitting paths of the light emitting assemblies and configured to combine the at least three colors of light emitted by each of the light emitting assemblies into combined light,
the half-wave plate is arranged on a light emitting path of one ray of the combined light and configured to change a polarization characteristic of the combined light,
and the polarizing beam splitter mirror is configured to combine the combined light emitted from the half-wave plate with another ray of the combined light.

2. The light source for a picture generation unit in an HUD according to claim 1, wherein there are two light emitting assemblies, each comprising at least one first light emitting element, at least one second light emitting element, and at least one third light emitting element; and the first light emitting element, the second light emitting element, and the third light emitting element are configured to emit a first color of light, a second color of light, and a third color of light, respectively.

3. The light source for a picture generation unit in an HUD according to claim 2, wherein a collimating lens is further arranged on each of light emitting paths of the first light emitting element, the second light emitting element, and the third light emitting element.

4. The light source for a picture generation unit in an HUD according to claim 3, wherein both the half-wave plate and the polarizing beam splitter mirror are arranged at a top of the dichroic beam splitter and combiner mirror.

5. The light source for a picture generation unit in an HUD according to claim 4, wherein the dichroic beam splitter and combiner mirror is provided with a first dichroic beam splitting and combining surface, a second dichroic beam splitting and combining surface, and a third dichroic beam splitting and combining surface; the first dichroic beam splitting and combining surface is configured to reflect the first color of light to the second dichroic beam splitting and combining surface; the second dichroic beam splitting and combining surface is configured to transmit the first color of light to the third dichroic beam splitting and combining surface, and to reflect the second color of light to the third dichroic beam splitting and combining surface; the third dichroic beam splitting and combining surface is configured to transmit the third color of light to the half-wave plate and the polarizing beam splitter mirror, and to reflect the first color of light and the second color of light to the half-wave plate and the polarizing beam splitter mirror; and the first color of light, the second color of light, and the third color of light incident into the half-wave plate are combined into first combined light, and the first color of light, the second color of light, and the third color of light incident into the polarizing beam splitter mirror are combined into second combined light.

6. The light source for a picture generation unit in an HUD according to claim 3, wherein both the half-wave plate and the polarizing beam splitter mirror are arranged at one end of the dichroic beam splitter and combiner mirror.

7. The light source for a picture generation unit in an HUD according to claim 6, wherein the dichroic beam splitter and combiner mirror is provided with a first dichroic beam splitting and combining surface, a second dichroic beam splitting and combining surface, and a third dichroic beam splitting and combining surface; the first dichroic beam splitting and combining surface is configured to reflect the first color of light to the second dichroic beam splitting and combining surface; the second dichroic beam splitting and combining surface is configured to transmit the first color of light to the third dichroic beam splitting and combining surface, and to reflect the second color of light to the third dichroic beam splitting and combining surface; the third dichroic beam splitting and combining surface is configured to transmit the first color of light and the second color of light to the half-wave plate and the polarizing beam splitter mirror, and to reflect the third color of light to the half-wave plate and the polarizing beam splitter mirror; and the first color of light, the second color of light, and the third color of light incident into the half-wave plate are combined into first combined light, and the first color of light, the second color of light, and the third color of light incident into the polarizing beam splitter mirror are combined into second combined light.

8. The light source for a picture generation unit in an HUD according to claim 7, wherein the polarizing beam splitter mirror is provided with a fourth beam splitting and combining surface and a fifth beam splitting and combining surface; the fourth beam splitting and combining surface is configured to reflect the first combined light emitted from the half-wave plate to the fifth beam splitting and combining surface; and the fifth beam splitting and combining surface is configured to transmit the second combined light, and to reflect the first combined light to a light emitting direction of the second combined light.

9. The light source for a picture generation unit in an HUD according to claim 2, wherein the two light emitting assemblies are arranged side by side.

10. The light source for a picture generation unit in an HUD according to claim 2, wherein the first light emitting element, the second light emitting element, and the third light emitting element are all laser diodes.
